(19) United States
(12) Patent Application Publication
(10) Pub. No.: US 2018/0101974 A1
(43) Pub. Date: Apr. 12, 2018

(54) PORTABLE TYPELET FILE

(71) Applicant: Clantech, Inc., Draper, UT (US)

(72) Inventor: Robert Adamson, III, Draper, UT (US)

(21) Appl. No.: 15/837,221

(22) Filed: Dec. 11, 2017

Related U.S. Application Data
(63) Continuation of application No. 14/713,825, filed on May 15, 2015, now abandoned.
(60) Provisional application No. 61/994,735, filed on May 16, 2014.

(51) Int. Cl. G06T 11/60

(52) U.S. Cl. CPC G06T 11/60; G06T 2207/10004

(57) ABSTRACT

The system includes a photo editor that applies text to photos. The editor enables entering any text onto a photo or image. The text is then enhanced by selecting a custom font, text color, stroke color, gradient color, opacity, alignment, pattern, shadow, glow, underline, container graphic, spacing, bold, italics, line spacing, skew, path, rotation and size. The text enhancements, including the selected font, are stored in a typelet enhancement file for hosting and distribution over networks such as the internet. The typelet files are downloaded and processed by the same photo editor. The enhancement files may be saved permanently on the device or loaded for temporary use. The photo editor also installs or exposes the embedded custom font to the operating system and then applies the other enhancements for the purpose of adding any text to a photo using the characteristics of the typelet file.

### CROSS REFERENCE TO RELATED APPLICATIONS

This application is a continuation of U.S. patent application Ser. No. 14/713,825, entitled “Portable Typelet File,” filed May 15, 2015, which claims priority under 35 USC § 119(e) to U.S. Patent Application No. 61/994,735, entitled “Portable Typelet File,” filed May 16, 2014, the entirety of which is herein incorporated by reference.

### BACKGROUND

The present disclosure relates to the field of computer text on photos technology. In particular, the disclosure relates to the methods, systems and computer programming products for applying enhanced text to photos and images using multiple enhancement styles such as non-standard fonts, colors and strokes.

Authors are in the business of conveying a message through the skillful and artistic use of characters often referred to as text. In addition to the message read from the text, authors are often also concerned with the impression made by the visual appearance of the text. For example, a skilled author would not draft a technical document using the font style of a child's picture book as doing so would diminish the seriousness and professionalism of the work.

Recently, network sites, such as Internet web sites, have been made available as a new authoring medium. For example, an author using an authoring program loaded on a computer can write an electronic document, such as a web page. The authoring program may contain a number of unique or non-standard fonts that allow the author to create the electronic document so as to have a unique or desired appearance. In general, a font includes a set of characters having a predefined typeface or configuration. Once created, the electronic document is stored on a server. A reader can then request and download the electronic document for display on the reader's computer.

Authors of conventional printed material can generally feel assured that, unless there is some damage to the printed material, the printed material will appear to the reader precisely as it was generated by the author. In contrast, electronic documents requested by a reader are displayed on the reader's computer using only the fonts that are currently loaded on the reader's computer. Accordingly, if the reader's computer does not contain the same fonts that were used by the author in creating the electronic document, the electronic document is displayed on the reader's computer in a form different than that originally created by the author. Generally, the operating system of the reader's computer replaces the unknown fonts with known fonts when displaying the electronic document.

Desktop users and mobile application users are becoming more experienced with various photo sharing technologies. These users may want to apply text or characters to the photos prior to sharing or saving the photos. These users are concerned with the impression made by the visual appearance as well as the message of the text on the photos. The fonts for rendering the text on the photos or images may include non-standard fonts created by the artists or professional designers which may be edited or updated frequently.

### SUMMARY

The disclosure relates to creation, distribution over the network and processing of text style files that include non-standard fonts and other text styles.

The visual appearance of the text is determined by various styles that can be applied to the text, for example the text on photos or images. Enhancement of the text includes the selection of, for example, custom font, text color, stroke color, gradient color, opacity, alignment, pattern, shadow, glow, underline, container graphic, spacing, bold, italics, line spacing, skew, path, rotation and size. The enhancements are stored in portable typelet files that are distributed over networks. Fonts stored in the typelet files are installed or exposed to the operating system and the other text styles, included in the typeset files, are processed by a typelet interpreting text-on-photos editor.

In some embodiments, these text styles can be saved as user defined typeset files for subsequent use. The user can also request and download the electronic typelet document file for applying text on photos. In some embodiments, the typelet file may be generated by artists or designers for sale or promotion. The typelet files are created as well as downloaded and interpreted by the typelet text-on-photos editor. If necessary, the fonts included in the typelet file are installed or exposed to the operating system so that the text-on-photos editor can render the characters and symbols on a photo using the typelet font and other typelet styles.

In one embodiment, typelet files created by artists, for example, are stored on network servers or cloud storage for subsequent downloading by users upon request. The text-on-photos editor used for selecting and downloading typelet styles can run as a dedicated application or embedded into other applications or programs in the form of an SDK (Software Development Kit).

The typelet files are free or purchased by users of the text-on-photos editor. In a mobile application, the typelet files may be purchased as in-app purchases through mobile application online stores such Apple® iTunes® or Google Play™.

### BRIEF DESCRIPTION OF THE DRAWINGS

To further clarify the above and other advantages and features of the disclosure, a more particular description of the disclosure will be rendered by reference to specific embodiments thereof which are illustrated in the appended drawings. It is appreciated that these drawings depict only typical embodiments of the disclosure and are therefore not to be considered limiting of its scope. The disclosure will be described and explained with additional specificity and detail through the use of the accompanying drawings in which:

FIG. 1A is a schematic diagram of an example of a system that provides a suitable network operating environment for the disclosure;

FIG. 1B is a schematic diagram of an example system for publishing, managing, distributing and selling the typelets and related content;

FIG. 2 is a flowchart of an example method for storing the typelets and related content;

FIG. 3A is a flowchart of an example method for integrating a text-on-photo editor in the form of an SDK into a web-based application;

FIG. 3B is a schematic diagram illustrating an example web-based application with an integrated text-on-photos editor being accessible to end users over a network;

FIG. 3C is a flowchart of an example method for downloading and using typelets to apply text to photos in a web-based application;

FIG. 4A is a flowchart of an example method for integrating text-on-photos editor into a mobile application;

FIG. 4B is a schematic diagram illustrating an example mobile-based application with an integrated text-on-photos editor being accessible to end users over a network;

FIG. 4C is a flowchart of an example method for downloading and using typelets to apply text to photos in a mobile-based application;

FIG. 5 is a block diagram illustrating an example font included in a typelet file being installed or exposed to a user device;

FIG. 6 is a schematic diagram of an example computing device according to an implementation of the present disclosure;

FIG. 7 is a schematic diagram of an example network architecture in which a developer computer can post a network document, to a server for access by browsing computers;

FIG. 8A is a schematic diagram of an example architecture that may be used to develop the network document as shown in FIG. 7 containing non-standard characters so as to facilitate delivery of the non-standard characters to the browsing computers;

FIG. 8B is a schematic diagram of an alternative example design of the architecture shown in FIG. 8A;

FIG. 9 illustrates an example of a data structure that may be used to deliver the non-standard characters to the browsing computers;

FIG. 10 is a flowchart showing an example method of operation of the present disclosure;

FIG. 11 is a schematic diagram of an example installation module operating between a browser and an operating system;

FIG. 12 is a schematic diagram of an example HTML network document incorporating features of the present disclosure; and

FIG. 13 is a schematic diagram of an example email based network document incorporating features of the present disclosure.

### DETAILED DESCRIPTION

The present disclosure extends to methods, systems, computer program products and data structures for allowing an operating system to have access to characters of non-standard fonts as well as other text styles included in the typelet network document or in other words, a portable typelet file.

In some embodiments, a tangible computer readable file identified as a typelet may be created with a text-to-photos editor or another program written for the purpose of creating typelet files. The typelet storage file is adapted for use with a computer or device coupled to a network such that the typelet storage file may be downloaded by a mobile application or an webpage, for example a rich internet web page, designed for adding text to photos or images. The typelet is a wrapper of text styles including a font file, text color, stroke color, gradient color, opacity, alignment, pattern, shadow, glow, underline, container graphic, spacing, bold, italics, line spacing, skew, path, rotation, size or other styles. The typelet may be downloaded for temporary use or saved for reuse on the text-to-photos editor mobile application device or rich web page browsing computer. The font contained in the typelet may be exposed or installed to the operating system of the mobile application device or browsing computer. User-defined text is then rendered to a display using the font and other styles for the purpose of saving the combination of text and photo to a file for saving or sharing. The font and other styles are used to render the text with the same appearance on all devices and browsing computers.

In some embodiments, the tangible computer readable typelet file contains all necessary style information including non-standard fonts for the rendering of enhanced text on photos or images. Examples of non-standard fonts include fonts that are not loaded or installed on the requesting computer and thus the corresponding characters cannot be displayed or otherwise used by the operating system thereof. To enable the computer requesting or opening the network document to generate the characters defined by the non-standard fonts, a font package containing computer readable formatting information necessary for an operating system to render the corresponding characters is provided. The formatting information defines the configuration of each character for a corresponding font using standard font file formats such as a scalable outline format. Installation software is also provided. The font package and installation software can be downloaded off of the server or otherwise loaded onto the computer.

The computer automatically executes the installation software which in tum either permanently installs or temporarily exposes the computer readable formatting information to the operating system so as to enable the operating system to render the characters of the non-standard fonts. As a result, a document, for example a photo including text, is generated and displayed by the computer using the same characters and/or symbols with which it was originally created.

Furthermore, in one embodiment the installation or exposure of the computer readable formatting information is done in a manner that the operating system of the computer has at least temporary access to utilize the characters of the non-standard fonts. For example, the operating system is able to use the characters of the non-standard fonts in the same way that it uses characters of original standard fonts. The operating system is thus able to efficiently copy, paste, print, modify, and otherwise edit the characters of the non-standard fonts.

In some embodiments, the tangible computer readable typelet file may be stored for download from a server or cloud storage or any type of network for example, the internet, intranet, wireless network, email or other networks capable of distributing files from one computer or device to another.

In some embodiments, the tangible computer readable typelet file contains categorization and other identifying information for the purpose of creating browsing and searching for typelet files from within a text-on-photos editor.

In one embodiment, a mobile application with the text-on-photos editor SDK, integrated into the mobile application, will download, install and interpret the typelet file. The mobile application may be downloaded over a network and installed onto a mobile device. Then using the typelet fonts and other styles included in the typelet file, the text-on-photos editor in the mobile application will apply the downloaded typelet styles to any text that a user enters onto a photo or to a portion of text on the photo that the user selected.

In another embodiment, a mobile application with a text messaging editor SDK, integrated into a mobile application, will download, install and interpret the typelet file. The mobile application may be downloaded over a network and installed onto a mobile device. Then using the typelet fonts and other styles specified by the typelet file, the text messaging editor in the mobile application will apply the downloaded typelet styles to any text that a user enters onto a blank or custom canvas or to a portion of text that the user selected. The message image is then sent as an instant message (IM), or MMS message (Multimedia Messaging Service), or email, or shared on a social network using any messaging technologies or web services.

In another embodiment, a mobile application with an animated text messaging editor SDK, integrated into a mobile application, will download, install and interpret the typelet file. The typelet contains text paths, timing and other attributes that are used for creating and rendering animation. The mobile application may be downloaded over a network and installed onto a mobile device. Then using the typelet fonts and animation styles, the animated text messaging editor in the mobile application will apply the downloaded typelet to any text that a user enters onto a blank or custom canvas or to a portion of text that the user selected. The message animated video is then sent as an instant message (IM), or MMS message, or email, or shared on a social network using any messaging technologies or web services.

In another embodiment, a browser loaded on a computer navigates to a network document such as an HTML web page that is hosted on a server. The webpage contains a text-on-photos editor written as HTML5 application, and ActiveX Control, a plugin or some other technology used by a dynamic web page. The text-on-photos editor may download a portable typelet file. Then using the typelet fonts and other styles, the text-on-photos editor in the web page will apply the downloaded typelet styles to any text that a user entered onto a photo or to a portion of text on the photo that the user selected.

In some embodiments, the typelet file may include a custom font. The user may select to install or expose that font to the operating system so that the text-on-photos editor can render text onto a photo using the typelet font and other styles without the need to re-download the typelet file. In some embodiments, once the font is installed or exposed to the operating system of a user device, the font can be used for rendering characters and symbols in other word-processing applications/software running on that user device.

In one embodiment, typelet files may be created by a text-on-photos editor. In other embodiments, the typelet files may be created by software specifically designed for use by artists or professional designers. In some embodiments, the typelet file may be stored on the server and may be updated to add new typelet styles and/or to include modification to existing typelet styles. In some embodiments, once the typelet file is updated, the server may send notification to users who previously downloaded that typelet file. The notification may include a link or instructions for those users to download the updated typelet file.

Embodiments within the scope of the present disclosure include non-transitory computer-readable media for carrying or having computer-executable instructions or data structures stored thereon. Such computer-readable media can be any available media that can be accessed by a general purpose or special purpose computer. By way of example, and not limitation, such computer-readable media can comprise physical storage media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

When information is transferred or provided over a network or another communications connection (either hardwired, wireless, or a combination of hardwired and wireless) to a computer, the computer properly views the connection as a computer-readable medium. Thus, any such connection is properly termed a computer-readable medium. Combinations of the above should also be included within the scope of computer-readable media. Computer-executable instructions include, for example, instructions and data which cause a general purpose computer, special purpose computer, or special purpose processing device to perform a certain function or group of functions.

The drawings and the following disclosure are intended to provide a brief, general description of a suitable computing environment in which the disclosure may be implemented. Although not required, one embodiment of the disclosure will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the disclosure may be practiced in network computing environments with many types of computer system configurations. The term “computer” as used herein is intended to include personal computers, hand-held devices such as personal information managers (PIMs), multi-processor systems, microprocessor-based or programmable consumer electronics, network PCs, minicomputers, mainframe computers, and the like. The term “computer” also includes distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

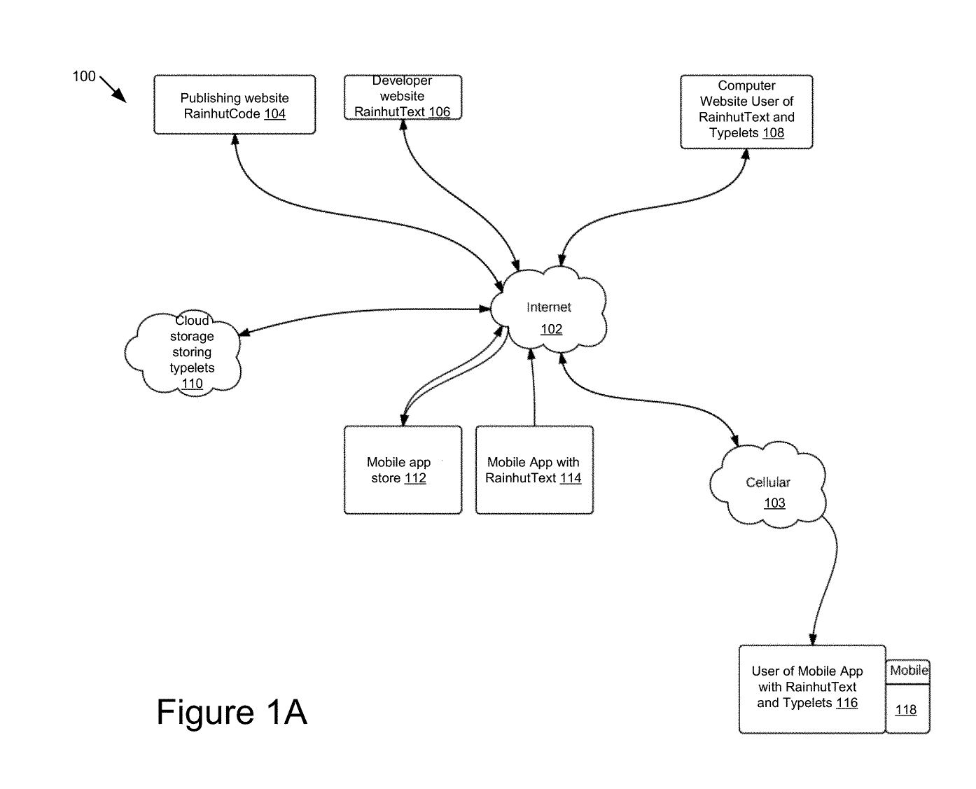

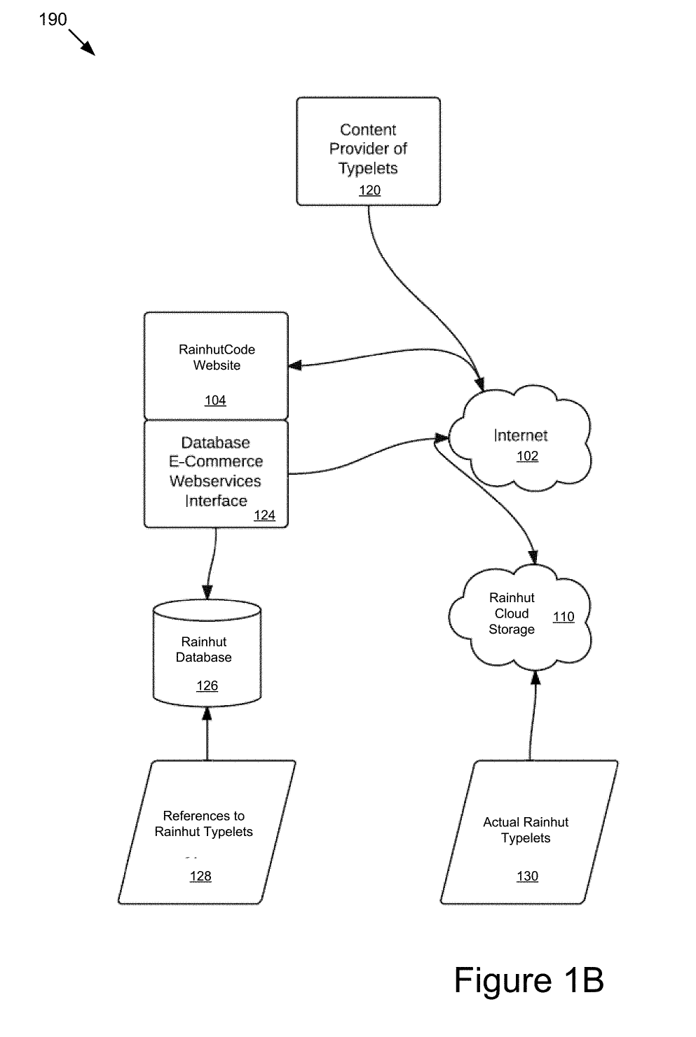

FIG. 1A is a schematic diagram illustrating an example network operating environment. The operating environment 100 may include a publishing site Rainhut 104 and a developer website RainhutText 106 coupled to a network, for example, the Internet 102. The publishing website Rainhut 104 provides typelets and related content for example, fonts and images such as text background images. The developer website RainhutText 106 provides and distributes SDKs to be integrated in web-based applications and mobile applications. In some embodiments, the web-based applications and/or the mobile applications enable the users to use the typelets on the text that they input onto photos or images. In one embodiment, hosting of typelets and content may be performed in the cloud storage 110, for example, the typelets and related text-style content may be stored on a cloud-based server. FIG. 1A similarly depicts access to the typelets and related content in the applications via the SDKs.

The operating environment 100 may further include computing devices coupled to the network 102. The computing devices may include a computer 108 and a mobile device 118. The user, for example the end user 116, may use text-on-photos application running on the computer 108 or on a mobile device 118 to apply typelets to text on photos. In some embodiments, the mobile device 118 may be coupled to the cellular network 103, which is coupled to the Internet 102. The operating environment 100 may further include a mobile application store 112, for example Apple iTunes® or the Google Play™ store. The end user 116 can download for free or purchase one or more mobile applications from the mobile application store 112. The mobile applications being purchased or free-downloaded can be subsequently installed on the mobile device 118.

FIG. 1B is a schematic diagram of an example system 190 for publishing, managing, distributing and selling the typelets and related content. The typelets 130 defining non-standard fonts and other text styles are generated and provided by a content provider of typelets 120, for example, an artist or a professional designer. The content provider 120 uploads the typelets 130 to the publishing website Rainhut 104. In some embodiments, the publishing website Rainhut 104 transfers the typelets to its cloud storage 110, and information about the typelet is then stored in the Rainhut relational database on the server, for example, the typelet database 126. In some embodiments, the typelet database 126 may include a reference 128 to each typelet being stored, for example, each typelet 130 may be identified by a unique identifier. The typelet database 126 may store, among other things, information about creator of each typelet so that a portion of profit from selling that typelet can be paid back to its creator. In some embodiments, the publishing website Rainhut 104 interacts with the typelet database 126 via the database e-commerce web-services interface 124.

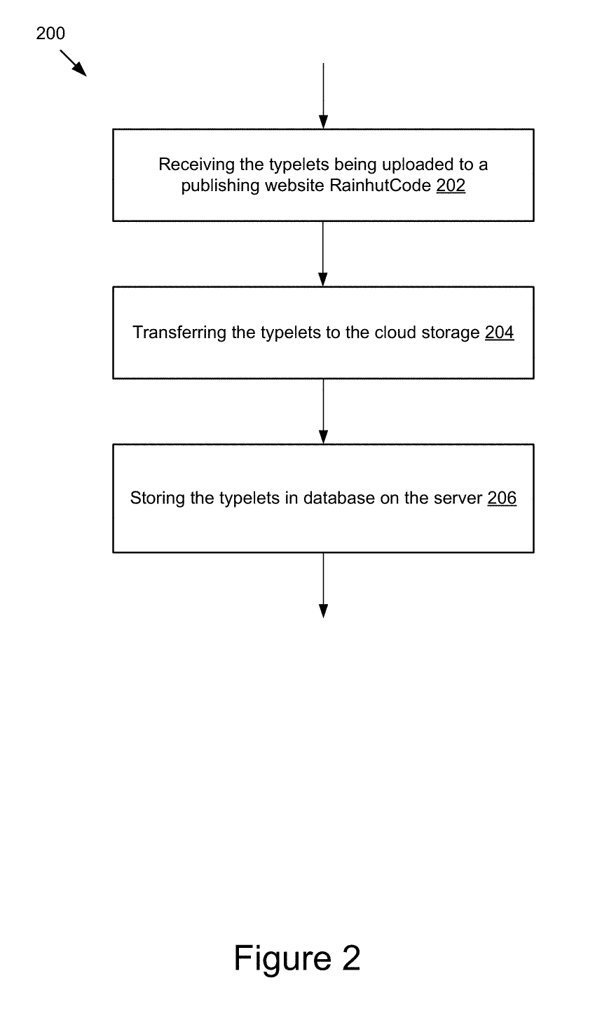

FIG. 2 is a flowchart of an example method 200 for storing the typelets and related content according to one embodiment of the present disclosure. The method 200 includes receiving 202 the typelets that the content provider 120 uploaded to the publishing website 104. The publishing website 104 transfers 204 the typelets to a cloud storage, for example, the cloud-based server 110 and stores 206 the typelets in the database, for example a typelet database 126, of the cloud-based server 110.

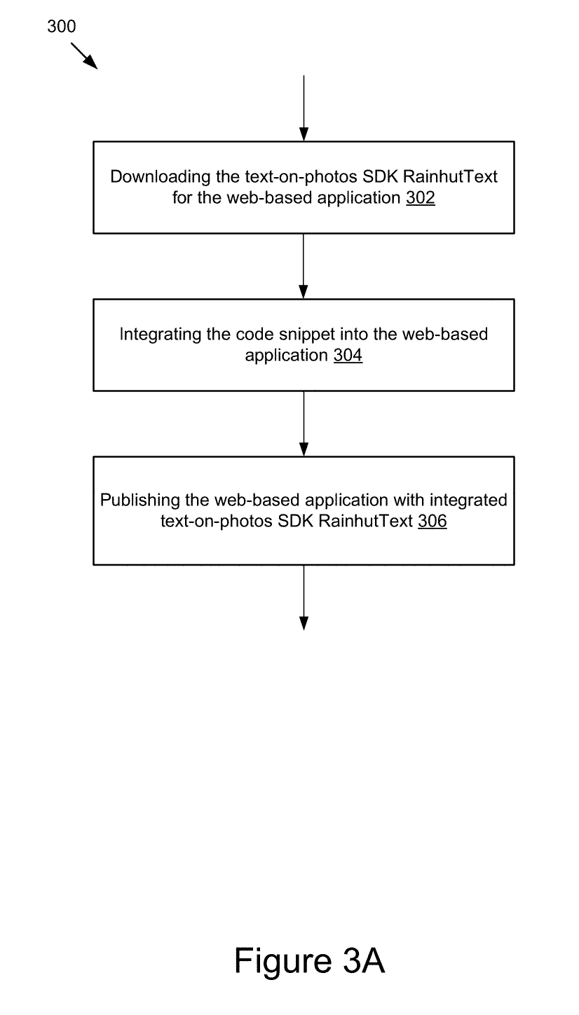

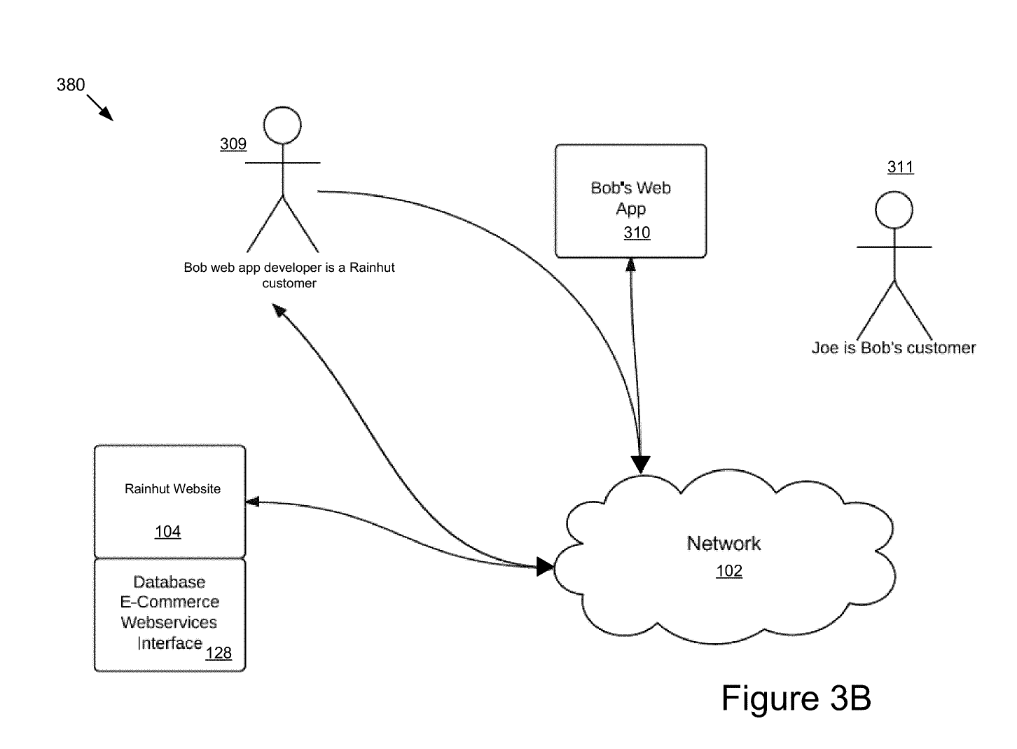

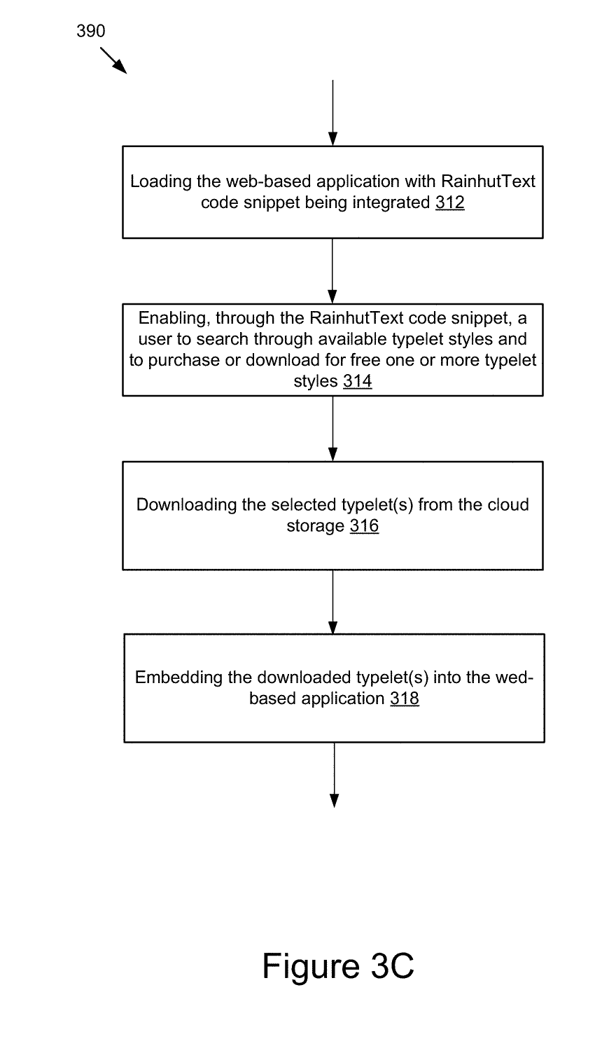

FIG. 3A is a flowchart of an example method for integrating a text-on-photo editor in the form of an SDK into a web-based application. For example, a web-based application developer named Bob, a customer of the developer website RainhutText, wants to provide the end users of his web-based application with option to add text on photos. Bob downloads the text-on-photo SDK for web-based application from the developer website RainhutText 106. In response to Bob RainhutText based application from website RainhutText 106 returns text-on-photo SDK code, for example in the form of code snippet. Bob integrates the SDK code into his web based application, for example, by copying and pasting the provided code snippet to his application by copy. Bob then publishes his application that now has RainhutText photo editing function being integrated, for example, on a server. In this example, method 300 for integrating a text-on-photo editor in the form of an SDK into a web-based application includes downloading 302 the text-on-photo SDK for the web-based application, integrating 304 the downloaded SDK into the web-based application, and publishing 306 the web-based application with the text-on-photo SDK included.

FIG. 3B is a schematic diagram 380 illustrating the web-based application with the integrated text-on-photos editor being accessible to the end users over the network 102. Once web-based application 310 developed by the web-based application developer 309, e.g. Bob in the above example, is published, an end user 311 may access and use the web-based application 310. The end user 311, named Joe for example, may use the typelets provided by the publishing website 104 to control the visual appearance of the text that he wants to add on a photo or image through the option that the web-based application 310 provides.

FIG. 3C is a flowchart of an example method for downloading and using typelets to apply text to photos in a web-based application. In the above example, the user 311 Joe is the end user of the web-based application 310. Web-based application 310 provides, among other functions, a function of editing text including text on photos. When Joe visits Bob's website, Bob's website and the web-based application 310 with the integrated text-editing code snippet, for example the text-on-photos editor, are loaded on Joe's user device, e.g. the computer 108. Joe may use the RainhutText text-on-photos editor to browse through available text style typelets and select one or more typelets to purchase. In some embodiments, the one or more typelets may be provided free. The selected typelet may then be downloaded from the cloud storage 110 and made available for Joe to use in the web-based application 1010 when he wants to apply text to photos. In this example, method 390 for downloading and using typelets to apply text to photos in a web-based application includes loading 312 the web-based application with the integrated text-on-photos code snippet, enabling 314, by integrating the text-on-photos code snippet into the web-based application, the end user to search through available typelet styles and to select one or more typelets to purchase or download for free. The method 390 further includes downloading 316 the one or more selected typelets from the server, for example the cloud-based server, and embedding 318 the one or more downloaded typelets into the web-based application.

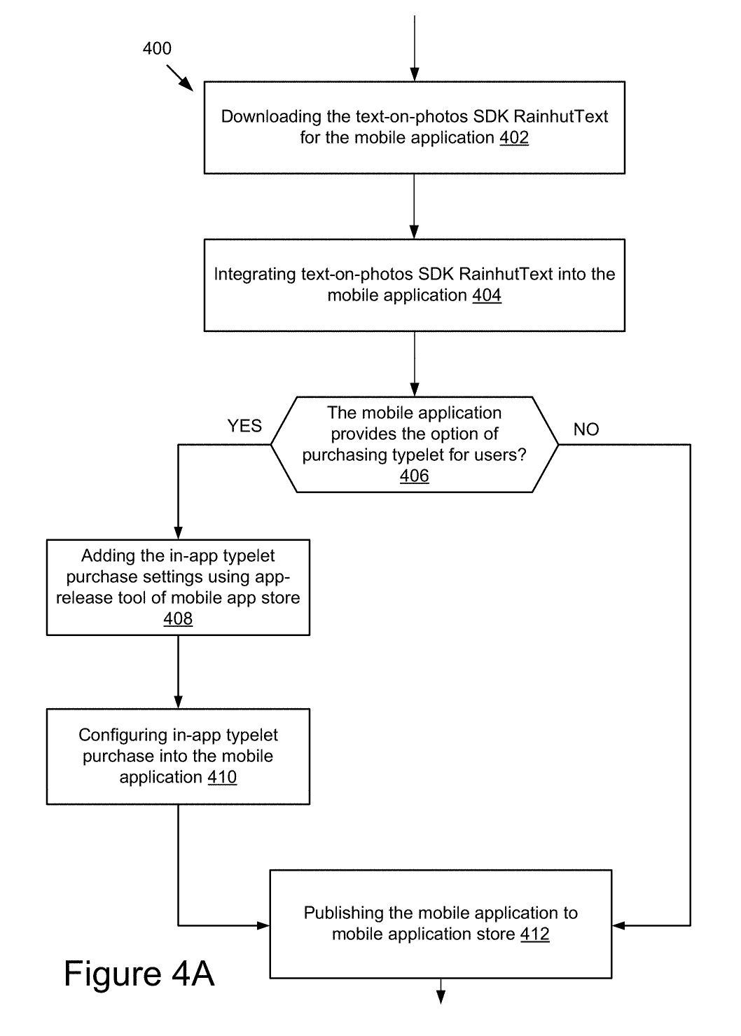

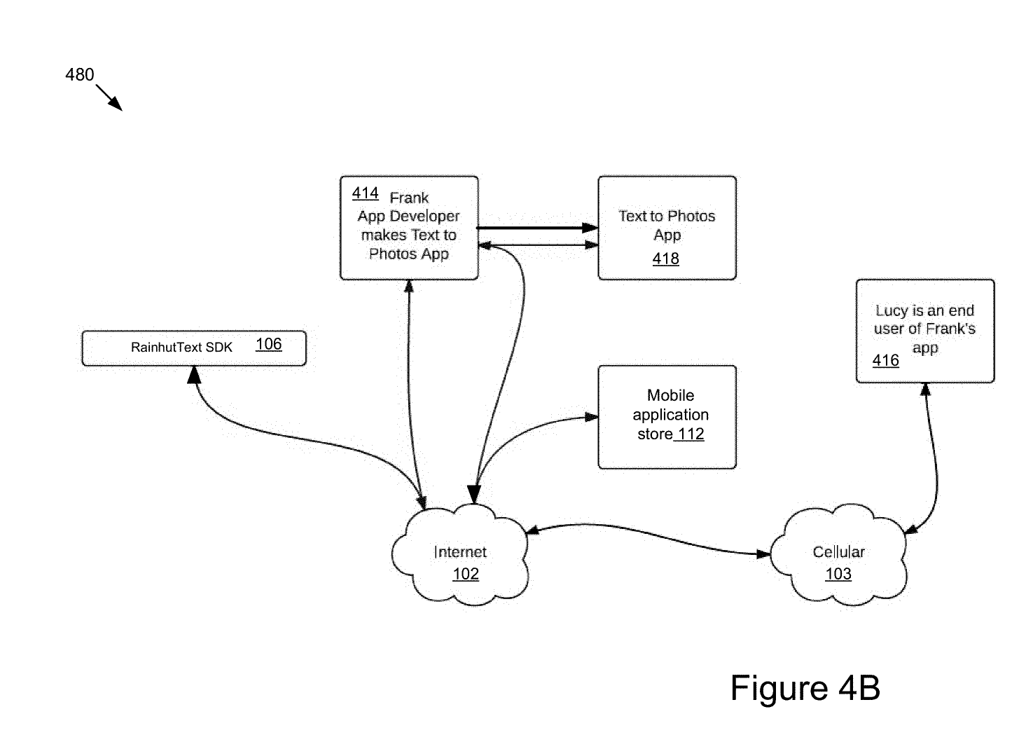

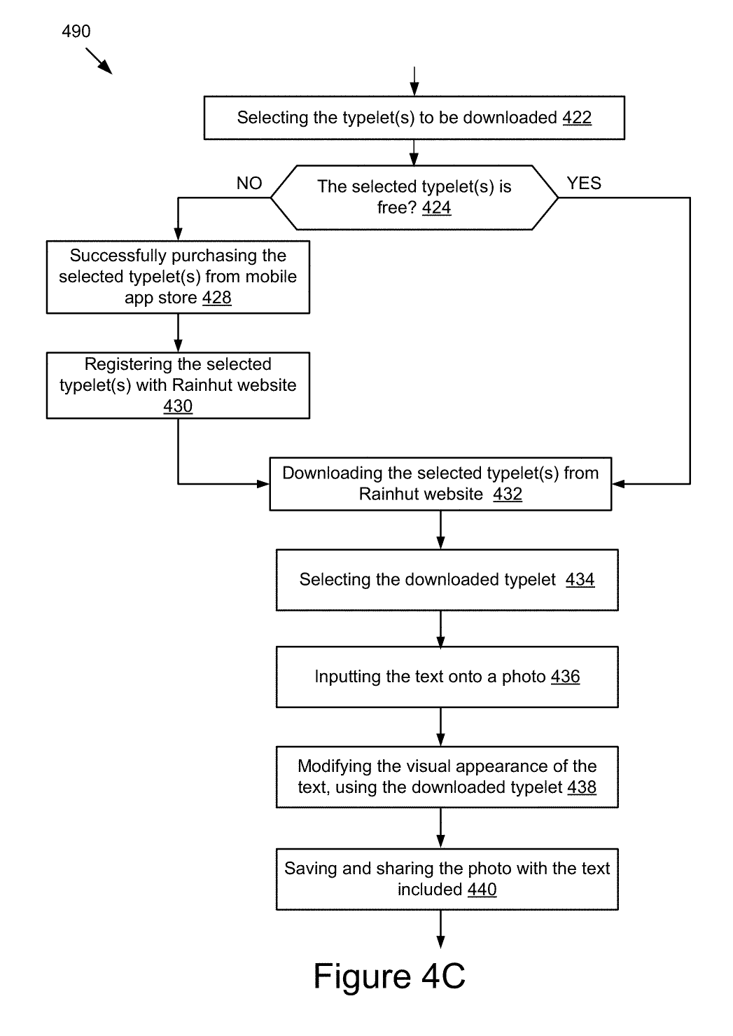

FIG. 4A is a flowchart of an example method for integrating text-on-photos editor in the form of a mobile-app-based SDK into a mobile application. For example, a mobile-application developer named Frank, a customer of the developer website RainhutText, creates an application for mobile devices. He wants his application to be able to support the user in adding enhanced text to photos. Frank visits the developer website RainhutText, signs up and downloads the text-on-photo SDK for mobile application, e.g. Mobile App RainhutText SDK, to include it in his own Mobile App. Frank may optionally configure his mobile application to include in-app purchasing capabilities so that the end users can purchase from within his application Typelet packs from a mobile app store (e.g., iTunes® or Google Play™). Frank then publishes his RainhutText and Typelet enabled application to the app store 112. In this example, method 400 for integrating text-on-photos editor in the form of a mobile-app-based SDK into a mobile application includes downloading 402 the text-on-photo SDK for the mobile application, integrating 404 the downloaded SDK into the mobile application. If the mobile application provides the option to purchase 406 typelets from within the app, the method 400 further includes adding 408 the settings for in-app purchase of typelet packs, e.g. using app-release tools of mobile app store such as iTunes® Connect, and configuring 410 the code snippet for in-app purchase of typelet packs into the mobile application. The method 400 further includes publishing 412 the mobile application to the mobile app store 112.

FIG. 4B is a schematic diagram 480 illustrating the mobile-based application with the text-on-photos editor integrated being accessible to the end users over the networks. For instance, the mobile application developer 414, e.g. Frank in the above example, publishes a mobile application 418 on the mobile application store 112. The mobile application 418 includes text-on-photo RainhutText SDK 106 to provide the end users with the ability to modify the visual appearance or stylize the text that they want to add on a photo or image. Once the mobile application 418 is released, the end user 416 may download the text-to-photo application 418, for example from the mobile app store 112, and use the application 418 on a mobile device. The mobile device of the end user 416, named Lucy for example, may be coupled to the cellular network 103. In some embodiments, the cellular network 103 may be connected to the Internet 102.

FIG. 4C is a flowchart of an example method 490 for downloading and using typelets to apply text to photos in a mobile-based application. In the above example, the user 416 Lucy is the end user of Frank's mobile application 418. Lucy downloads Frank's application 418 from the mobile app store 112 and runs the application 418. Lucy uses the text-on-photo RainhutText Editor provided within the mobile application 418 and browses through available typelets to find the typelet style she wants to apply to the text. For example, Lucy finds a comic typelet she likes in this rendition. If the comic typelet is free, Lucy then downloads the typelet from publishing website Rainhut 104 for free. Otherwise, Lucy may purchase the typelet from the mobile app store 112 using the application's in-app purchase feature. After the purchase process completes successfully, the selected typelet for Lucy's mobile device is registered with the publishing website Rainhut 104. Lucy then downloads the selected typelet from the Rainhut website 104. Lucy chooses the new typelet she has bought and types the phrase “Pow!” into the input box of the text-on-photo RainhutText editor. The inputted text appears in the comic Typelet styles on the photo and Lucy may change the text format, colors, sizes, etc. of the text using the RainhutText editor. Lucy may rotate or apply animation effect to the text using the RainhutText editor. Lucy then saves the photo with the text being formatted and may share her photo with her friends and family via social network or electronic messages. In this example, method 490 for downloading and using typelets to apply text to photos in a mobile-based application includes selecting 422 typelet(s) to be downloaded, and determining 424, whether the selected typelet is free. If the selected typelet is not free, the method 490 further includes purchasing 428 the selected typelet from the mobile application store, and registering 430 the selected typelet with the typelet publishing website when the purchase process completes successfully. The method 490 may further include downloading 432 the selected typelet from the typelet publishing website. In some embodiments, the process of registering the selected typelet with the publishing website and downloading the selected typelet from the publishing website may happen automatically after the purchase successfully completes without action on the part of the end user. In some embodiments, the selected typelet is automatically downloaded from the typelet publishing website if the selected typelet is distributed free. The method 490 may further include selecting 434 the downloaded typelet, inputting 436 the text onto a photo, modifying 438 the visual appearance of the inputted text using the downloaded typelet(s) and/or other existing typelets that the mobile application provides, saving and sharing 440 the photo with the text included within the photo.

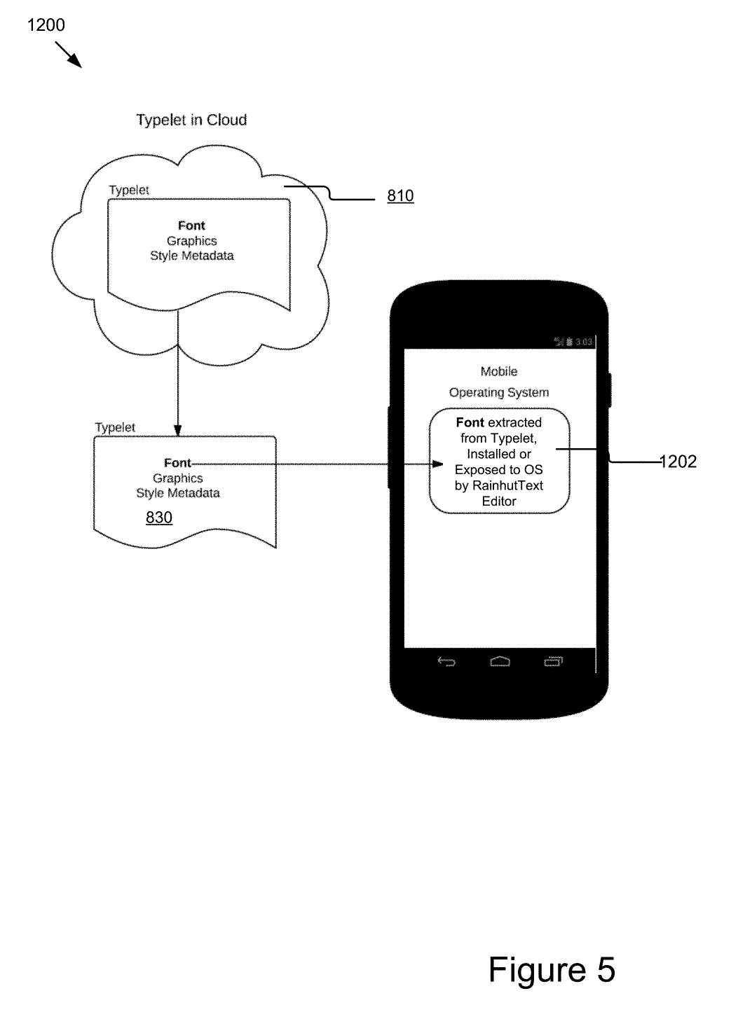

FIG. 5 is an example block diagram 500 illustrating a font included in a typelet file being installed or exposed to a user device 502. In some embodiments, the typelet file 130 may be downloaded over the internet network 102 from the cloud storage 110 to the user device 502, for example a computer 108 or a mobile device 118. The typelet is processed by the RainhutText text-on-photo editor of the mobile application installed on the user device. The embedded font defined by the typelet style is installed or exposed to the device or computer operating system so that the text associated with the typelet is rendered using the corresponding embedded font.

In some embodiments, the text-on-photos application running on a computer device or a mobile device may record or create tangible computer readable typelet files. In some embodiments, the text-on-photos application running on a computer device or a mobile device may be used to browse, download and interpret tangible computer readable typelet files for the purpose of rendering, displaying and applying enhanced text on photos and images. In some embodiments, the text-on-photos application running on a computer device or a mobile device may be used to browse, download and interpret a tangible computer readable typelet file, extract fonts and expose or install the fonts to the downloading device or computer's operating system for the rendering of text with the exact same font appearance on all devices and computers.

In some embodiments, upon the closing of a text-on-photos mobile application or a web-based text-on-photos application running on a browser, the temporary files, for example a temporary text style typelet file, or memory maps may be deleted or otherwise made inaccessible. In some embodiments, a dynamic proprietary file format may be used in the creation and interpretation of the tangible computer readable typelet file.

In some embodiments, a text-on-photos software developer kit (SDK) used to create computer programs or mobile applications that support adding text onto photos or images may include a text-on-photos editor. The text-on-photos editor uses the tangible computer readable typelet files for the purpose of applying text on photos.

In some embodiments, the text-on-photos computer program, the text-on-photos mobile application or the text-on-photos SDK may be used to track and report over a network the usage of tangible computer readable typelet files used for applying text to photos or images. In some embodiments, the text-on-photos computer program, the text-on-photos mobile application or the text-on-photos SDK may be used to browse, download and purchase over a network tangible computer readable typelet files used for applying text to photos or images.

In some embodiments, the text-on-photos computer program, the text-on-photos mobile application or the text-on-photos SDK may be used to browse, download and purchase over a network tangible computer readable typelet files for applying enhanced text on photos or images and saving those photos and images to the computer or other types of user device. In some embodiments, the text-on-photos computer program, the text-on-photos mobile application or the text-on-photos SDK may be used to browse, download and purchase over a network tangible computer readable typelet files for applying enhanced text on photos or images and then sharing those photos over social networks, emails, upload sites and text messaging.

In some embodiments, the tangible computer readable typelet file may include a background image for the text being inputted, for example an SVG vector based text bubble image. This typelet background image may include embedded text path information. When a user of the typelet SDK editor enters text, the text is rendered automatically into the typelet text bubble along the embedded path even as the typelet background image is moving. In some embodiments, the inputted text may be associated with the typelet background image as the background image is moving.

In some embodiments, to enable the computer requesting or opening the network document to generate the characters defined by the non-standard fonts, a font package containing computer readable formatting information necessary for an operating system to render the corresponding characters is provided. The formatting information defines the configuration of each character for a corresponding font using standard font file formats such as a scalable outline format. Installation software is also provided. The font package and installation software can be downloaded off of the server or otherwise loaded onto the computer. In one embodiment, a browser loaded on a computer navigates to a network document, such as a web page, that is hosted by a server. In an alternative embodiment, the network document can be any HTML document stored on any form of computer readable medium that can be opened by a browser.

In some embodiments, the computer automatically executes the installation software which in tum either permanently installs or temporarily exposes the computer readable formatting information to the operating system so as to enable the operating system to render the characters of the non-standard fonts. As a result, the network document is generated and displayed by the computer using the same characters with which it was originally created.

Furthermore, in one embodiment the installation or exposure of the computer readable formatting information is done in a manner that the operating system of the computer has at least temporary access to utilize the characters of the nonstandard fonts. That is, the operating system is able to use the characters of the nonstandard fonts in the same way that it uses characters of original standard fonts. The operating system is thus able to efficiently copy, paste, print, modify, and otherwise edit the characters of the non-standard fonts.

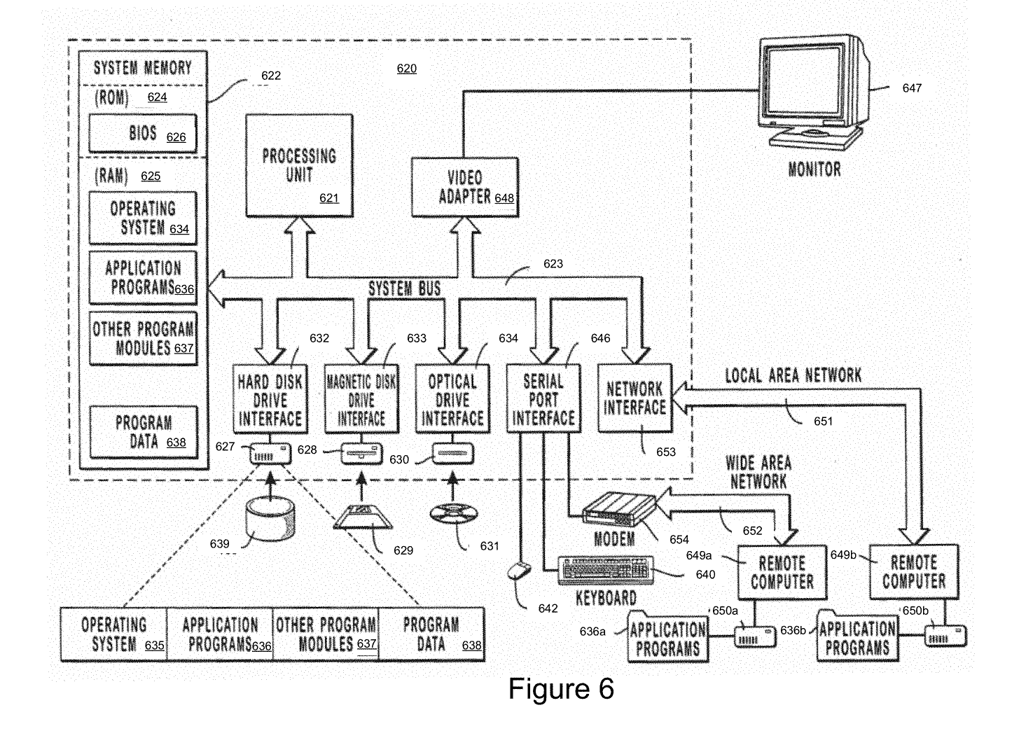

With reference to FIG. 6, one example of a system for implementing the disclosure includes a general purpose computing device in the form of a conventional computer 620. Conventional computer 620 includes a processing unit 621, a system memory 622, and a system bus 623 that couples various system components including the system memory 622 to the processing unit 621. The system bus 623 may be any of several types of bus structures including a memory bus or memory controller, a peripheral bus, and a local bus using any of a variety of bus architectures. The system memory includes read only memory (ROM) 624 and random access memory (RAM) 625. A basic input/output system (BIOS) 626, containing the basic routines that help transfer information between elements within the computer 620, such as during start-up, may be stored in ROM 624.

The computer 620 may also include a magnetic hard disk drive 627 for reading from and writing to a magnetic hard disk 639, a magnetic disk drive 628 for reading from or writing to a removable magnetic disk 629, and an optical disk drive 630 for reading from or writing to removable optical disk 631 such as a CD-ROM or other optical media. The magnetic hard disk drive 627, magnetic disk drive 628, and optical disk drive 630 are connected to the system bus 623 by a hard disk drive interface 632, a magnetic disk drive-interface 633, and an optical drive interface 634, respectively. The drives and their associated computer-readable media provide nonvolatile storage of computer-executable instructions, data structures, program modules and other data for the computer 620. Although the exemplary environment described herein employs a magnetic hard disk 639, a removable magnetic disk 629 and a removable optical disk 631, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 639, magnetic disk 629, optical disk 631, ROM 624 or RAM 625, including an operating system 635, one or more application programs 636, other program modules 637, and program data 638. A user may enter commands and information into the computer 620 through keyboard 640, pointing device 642, or other input devices (not shown), such as a microphone, joy stick, game pad, satellite dish, scanner, or the like. These and other input devices are often connected to the processing unit 621 through a serial port interface 646 coupled to system bus 623. Alternatively, the input devices may be connected by other interfaces, such as a parallel port, a game port or a universal serial bus (USB). A monitor 647 or another display device is also connected to system bus 623 via an interface, such as video adapter 648. In addition to the monitor, personal computers typically include other peripheral output devices (not shown), such as speakers and printers.

The computer 620 may operate in a networked environment using logical connections to one or more remote computers, such as remote computers 649a and 649b. Remote computers 649a and 649b may each be another personal computer, a server, a router, a network PC, a peer device or other common network node, and typically include many or all of the elements described above relative to the computer 620, although only memory storage devices 650a and 650b and their associated application programs 636a and 636b have been illustrated in FIG. 6. The logical connections depicted in FIG. 6 include a local area network (LAN) 651 and a wide area network (WAN) 652 that are presented here by way of example and not limitation. Such networking environments are commonplace in office-wide or enterprise-wide computer networks, intranets and the Internet.

When used in a LAN networking environment, the computer 620 is connected to the local network 651 through a network interface or adapter 653. When used in a WAN networking environment, the computer 620 may include a modem 654, a wireless link, or other means for establishing communications over the wide area network 652, such as the Internet. The modem 654, which may be internal or external, is connected to the system bus 623 via the serial port interface 646. In a networked environment, program modules depicted relative to the computer 620, or portions thereof, may be stored in the remote memory storage device. It will be appreciated that the network connections shown are exemplary and other means of establishing communications over wide area network 652 may be used.

FIG. 6 is provided by way of illustration only. The principles of the present disclosure may be implemented in any operating environment that is able to implement the principles of the present disclosure. For example, given suitable software and/or adaptation, general-purpose computers, special-purpose computers or special purpose processing devices (whether now developed or to be developed in the future) might implement the principles of the present disclosure. In addition, the principles of the present disclosure may be implemented by software, hardware, firmware or any combination thereof.

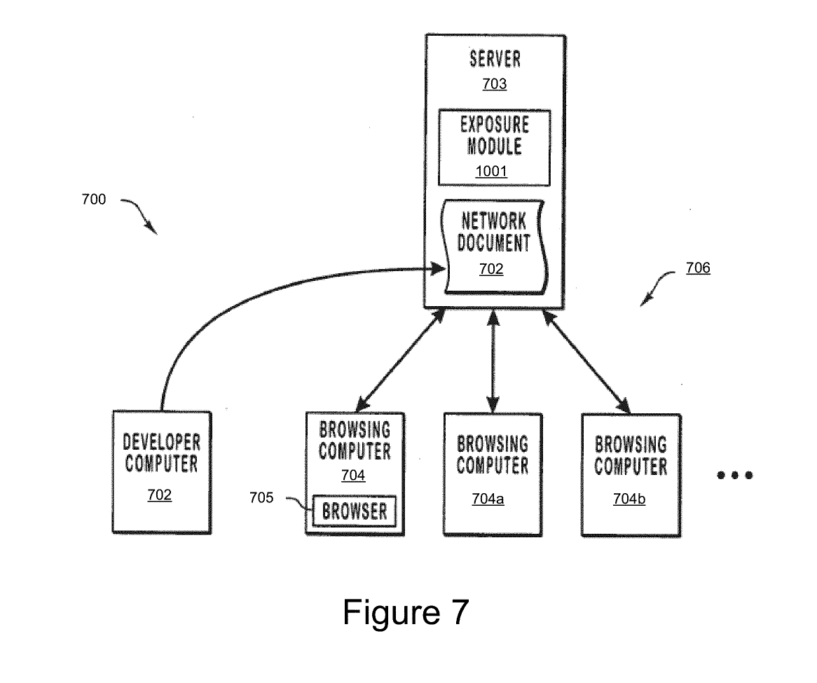

FIG. 7 illustrates a typical network environment 700 in which one embodiment of the present disclosure is incorporated. Network environment 200 includes a developer computer 701 and a browsing computer 704. Browsing computer 704 is loaded with a network browser 705, such as MICROSOFT Internet Explorer or NETSCAPE NAVIGATOR, and is selectively coupled in electrical communication with a network 706. Network 706 can comprise one or more LANs such as LAN 651 and/or one or more WAN s such as WAN 652 as described with FIG. 6. In the embodiment depicted, network 706 includes a server 703. Server 703 can comprise a conventional Internet server or any other type or combination of computers as previously discussed herein. Browser 705 is configured to enable browsing computer 704 to access and communicate with server 703.

As used herein, the term “developer computer” and “browsing computer” is each intended to include “computers” as previously defined herein. One example of developer computer 701 and browsing computer 704 is computer 620 as discussed with regard to FIG. 6. In one embodiment as depicted in FIG. 7, one or more additional browsing computers 704a-b can also be electrically coupled with network 706. Likewise, although not required, developer computer 701 can also be electrically coupled with network 706 through a network browser.

Developer computer 701 is used to create a network document 702. Network document 702 is shown as being hosted or stored on server 703. As used herein, the term “network document” is intended to mean any form of an electronic file that can have a display character embedded therein, attached thereto, referenced therein, such as through a link, or can otherwise be associated therewith.

The term “character” as used herein is intended to mean any discrete letter, number, symbol, design, mark, sign, figure, text, or the like that is currently known or created in the future. With regard to computer code, a “character” also includes a bit value qualified by a corresponding font or default font. For example, as an HTML document, such as a web page, is created, the text which is to be displayed during normal viewing is typed in and bounded on each side by a specific font tag. The font tag defines the name of the font, such as Times New Roman or Courier. The computer reads each of the characters of the text as a numerical bit value. As an operating system processes the HTML document, the operating system read the font tag and determines whether a font file corresponding to the font tag is loaded in the standard font directory. Each font file includes the formatting information necessary for the operating system to render each character of the font.

If the font file corresponding to the font tag is loaded in the standard font directory, the operating system determines the bit value of each character and then renders each character by matching the bit value to the formatting information in the corresponding font file. Accordingly, although the letter “A” may always have the same bit value, its configuration can be changed by simply associating it with different font tags. Accordingly, in one embodiment computer executable instructions identifying a display character includes the bit value for a character and the font or default font qualifying the bit value.

The term “display character” as used herein means the characters of a network document which are intended to be or can selectively be displayed during normal viewing of the network document. “Display characters” are in contrast to computer executable instructions or source code comments.

The term “non-standard character” is intended to mean display characters of a network document for which the corresponding formatting information is not loaded on or otherwise available to a browsing computer for rendering the character prior to requesting or otherwise receiving the network document. It is appreciated that the determination of whether a character qualifies as a non-standard character is based solely upon what formatting information is loaded upon or otherwise available to a discrete browsing computer. As different browsing computers may have different fonts and corresponding formatting information available thereon, a list of non-standard characters for a discrete network document can change between different browsing computers even if the network document remains the same.

Furthermore, as used herein, a “font” defines one or a group of characters each having a defined configuration. There are thousands of different known fonts. Examples of conventional letter fonts include the characters associated with Times New Roman, Arial, and Courier. Examples of conventional symbol fonts found on MICROSOFT Word 2000 include the characters associated with Symbol, Tahoma, and WP Math A. Furthermore, just as an infinite number of different characters can be created, it is appreciated that an infinite number of unique and different fonts can be created.

By way of example and not by limitation, “network documents” can include web pages and other forms of electronic files that can be posted on the Internet; email communications including those that have an HTML document attached thereto; and an HTML document that has embedded therein or reference to any form of application file that contains a display character. Examples of such application files include text files, WORDPERFECT files, power point presentation files, and other special application files.

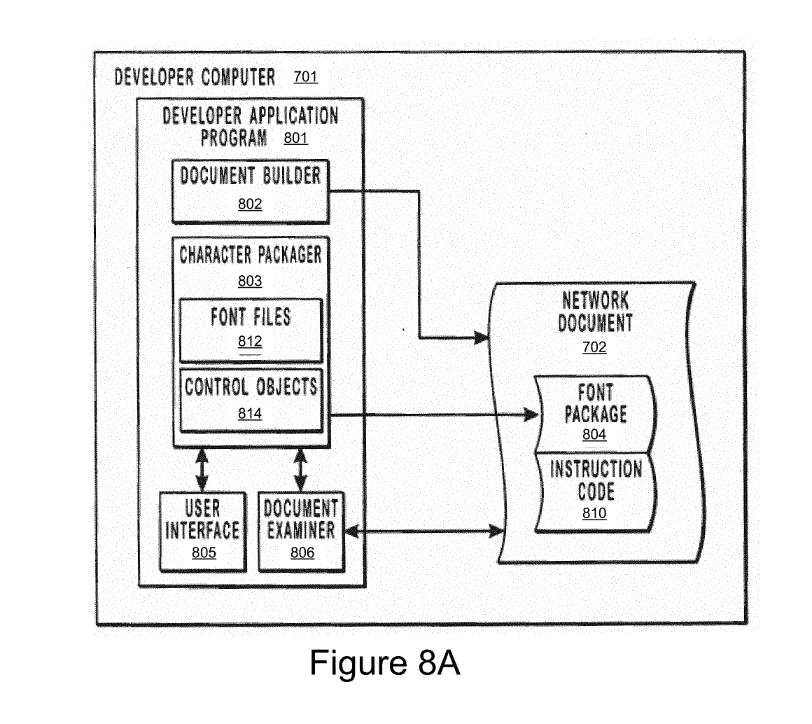

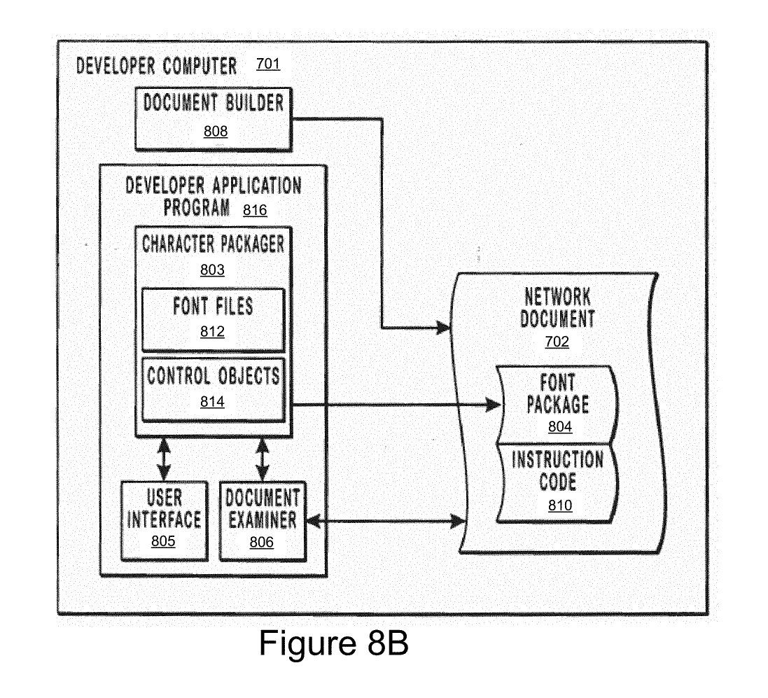

FIG. 8A illustrates one embodiment of developer computer 701 of FIG. 7 having a developer application program 801 loaded thereon. In one embodiment, developer application program 801 includes a document builder 802 that allows an author to generate network document 702. For example, document builder 802 can be any type of existing program, such as MICROSOFT FRONTPAGE or MICROSOFT Word, or a specially written program which is capable of forming an HTML document.

Developer application program 801 also includes a character packager 803. One function of character packager 803 is to generate a font package 804 that is incorporated into or linked to network document 702. As discussed below in greater detail, font package 804 includes the formatting information necessary for the operating system of browsing computer 704 to generate one or more display characters, generally non-standard characters, when browsing computer 704 downloads and displays network document 702.

That is, as previously discussed, one of the problems of the prior art is that an increasing number of electronic documents are being created using unique characters wherein corresponding formatting information is not loaded on or otherwise available to a browsing computer, i.e., non-standard characters. Accordingly, when a browsing computer downloads the electronic document over a network or otherwise receives and opens the electronic document, the electronic document is displayed on the browsing computer without the non-standard characters or by replacing the non-standard characters with other characters that are available to the browsing computer. In any event, the electronic document is displayed in a format different from that intended at its creation.

In part, character packager 803 identifies the display characters used in network document 702 that are to be included in font package 804. Character packager 803 is a program that can be written in C++ or other languages and may run as either a standard desktop application or within a web browser via its own plugin technology. The identification of the display characters can be accomplished in a variety of different ways. By way of example and not by limitation, in one embodiment a user interface 805 allows the author or another to identify specific characters, groups of characters, or entire fonts that are to be included within font package 804. For example, character packager 803 can enable manual input, manual highlighting, manual selection from a table, and/or other form of manual selection of the specific characters, groups of characters, and/or fonts which are to be included in font package 804. This selection of characters can be accomplished either before, during, or after the creation of network document 702.

In general, the characters and/or groups which are selected include those characters which the individual making the selection believes the corresponding formatting information is most likely not loaded on or otherwise available to browsing computer 704 which will ultimately display network document 702. In one embodiment, rather than selecting specific characters that are actually used on network document 702, character groups and/or fonts can be selected even if all of the characters of a group or font are not used within network document 702. In yet another embodiment, all fonts where at least one character thereof is used within network document 702 can be selected for inclusion into font package 804.

Alternatively or in addition to user interface 805, a document examiner 806 can be used. Document examiner 806 examines network document 702 and, based on pre-established parameters, automatically selects characters, character groups, and/or fonts for incorporation into font package 804. For example, in one embodiment document examiner 806 can contain a list of characters, character groups, and/or fonts (hereinafter, “character list”), selected from the entire inventory of characters and fonts available for use by document builder 802 in the creation of document 702, which are considered likely to be non-standard characters to browsing computer 704. For example, the character list may correspond to those characters or fonts which are not standard to Windows® 2000 or some other predefined operating system.

Simultaneously with or subsequent to the creation of network document 702, document examiner 806 searches network document 702 and identifies all characters within document 702 that are found on the character list. The identified characters are then incorporated into character packager 803. Alternatively, document examiner 806 can search electronic document 702 and identify all of the fonts used therein that are located on the character list. The identified fonts are then incorporated into character packager 803. It is appreciated that there are a variety of different ways in which document examiner 806 can select the characters or fonts. For example, document examiner 806 can also include a list of standard characters and/or fonts and then review network document 702 to identify those characters and/or fonts that are not on the standard list.

As the different characters, character groups, and/or fonts are selected by user interface 805 and/or document examiner 806, character packager 803 creates corresponding font files 812. Each font file 812 has a font name and corresponds to a defined character, group of characters, or entire font. Specifically, each font file 812 includes all of the computer readable formatting information necessary for a computer operating system to render each of the characters associated with the corresponding font file 812. Although the amount of formatting information can vary, the type of formatting information is generally the same as that for standard fonts. For example, the formatting information is sufficient to enable display, printing, copying, pasting, and other conventional forms of manipulation such as bolding, underlining, strikeout, and the like.

The formatting information can be in any standard font file format. In one embodiment, the formatting information is in a scalable outline form such as TRUETYPE. Examples of other formats include raster and stroke. It is appreciated that meta files can also be used.

Although each font file 812 can include formatting information for only one character, more often, each font file 812 includes information on a group of characters or a complete font. For example, document examiner 806 can be used to select all characters of a given font used within network document 702. This group of characters, which is typically less than the entire font, is assigned to a specific font file 812. The file is typically given a name other than the conventional font name so that the sub-set of the font does not accidentally replace the complete font which may already be loaded on a browsing computer.

Character packager 803 also creates a discrete control object 814 for each corresponding font file 812. Contained within each control object 814 is select handling information which can be used to selectively enhance, manipulate, or otherwise alter the characters within the corresponding font file 812. By way of example and not by limitation, the handling information can facilitate stretching, twisting, looping, unique shadowing, or any other manipulation of characters that is not standard to an operating system. For example, the handling information generally does not include the information necessary for bolding, underlining, strikeout, italicizing, outlining, and the like.

Once font files 812 and control objects 814 are completed, character packager 803 combines and compresses font files 812 and control objects 814 so as to form font package 804.

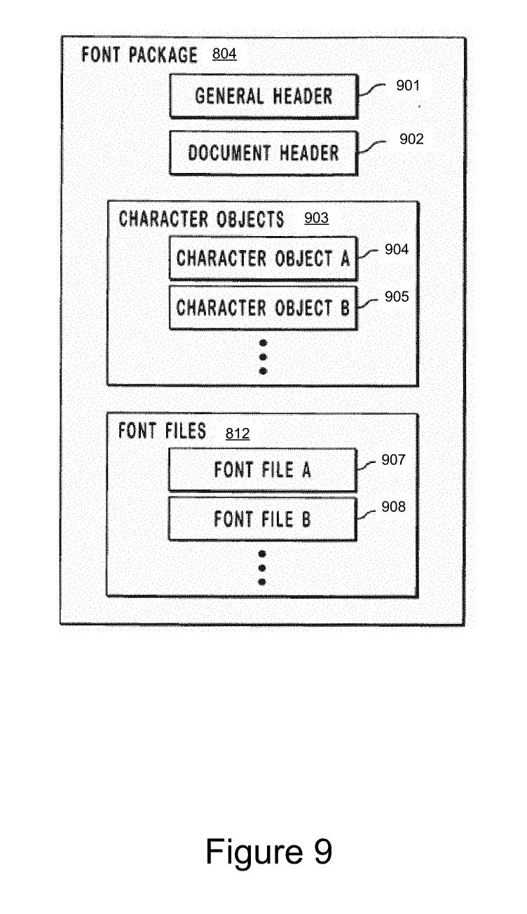

FIG. 9 illustrates one embodiment of a data structure for font package 804. As shown therein, font package 804 includes a general header 901 that contains general information about font package 804 in an uncompressed state. A document header 902 is in a compressed state and includes general document and version information.

The discrete font files 812 are also located within font package 804 in a compressed state. For each font file 812 has a corresponding character object 903. Character objects 903 are substantially the same as control objects 814 in that each character object 903 includes the handling information for the characters of the corresponding font file 812. Unlike control objects 814, however, character objects 903 specifically reference the corresponding font file 812 so as to facilitate handling of the characters.

For example, character objects 903 include one or more character objects such as character object A (labeled 904) and character object B (labeled 905). Each character object references and describes handling and version information for a corresponding font file of font files 812. For example, character object A references and describes corresponding handling and version information for font file A (labeled 907), and character object B references and describes corresponding handling and version information for font file B (labeled 908).

In one embodiment, character packager 803 can also encrypt font package 804. It is appreciated that the data structure of font package 804 can have a variety of different configurations and that the files therein need not be compressed. Furthermore, in one embodiment, control objects 814 and character objects 903 can be eliminated. That is, where it is only desired to generate the characters as opposed to the additional handling thereof, font package 804 can be created with only font files 812.

Once font package 804 has been generated, it is assigned an extension such as, for example, “.TRZ”. In one embodiment, font package 804 is imbedded directly within network document 702. Alternatively, font package 804 can be stored in a different directory than network document 702 at server 703 and can also be stored at a different server. In this latter case, network document 702 references font package 804 using a corresponding tag. Accordingly, when network document 702 is downloaded to browsing computer 704, font package 804 is also downloaded. In this description and in the claims, a file being “referenced” in a document means that downloading the document also causes downloading of the file such as through corresponding tags, such as embedded tags or object tags, or other computer executable instructions.

In addition to the creation of font package 804, character packager 803 also creates instruction code 810, depicted in FIG. 8A, that is either referenced by or embedded within network document 702. Instruction code 810 comprises computer executable instructions that facilitate downloading onto browsing computer 704 an installation module 1101. As discussed below, installation module 1101 is loaded onto server 703 (FIG. 7) and comprises computer-executable instructions for automatically installing font package 804 on browsing computer 704 when browsing computer 704 requests network document 702. In one embodiment, installation module 1101 comprises an ActiveX® control. Instruction code 810, in one embodiment, comprises a Multipurpose Internet Mail Extension (MIME) type which corresponds to the extension of the font package (e.g., “.TRZ”). The file name and relative path of installation module 1101 are identified in instruction code 810 within a tag that indicates to the browser that installation module 1101 is to be downloaded. In this regard, network document 702 references installation module 1101 for downloading with network document 702.

As depicted in FIG. 7, once font package 804 and instruction code 810 have been included in network document 702, network document 702 is loaded onto server 703 so as to accessible by browser computer 704 over network 706. As mentioned above, also loaded onto server 703 is installation module 1101.

In contrast to the system depicted in FIG. 8A, it is appreciated that document builder 802 need not be included in developer application program 801. This is because it is not necessary that character packaging occur concurrently with the building of network document 702. For example, as depicted in FIG. 8B, network document 702 is generated using a conventional document builder 808 that is completely separate from a developer application program 816. Examples of document builder 808 include all standard and specially designed applications used for creating HTML documents. Once network document 702 is created, character packager 803 of developer application program 816 creates font package 804 as previously discussed above with regard to FIG. 8A. In yet another embodiment, network document 702 can be created on a separate computer and then loaded onto developer computer 701 where developer application program 816 is applied thereto.

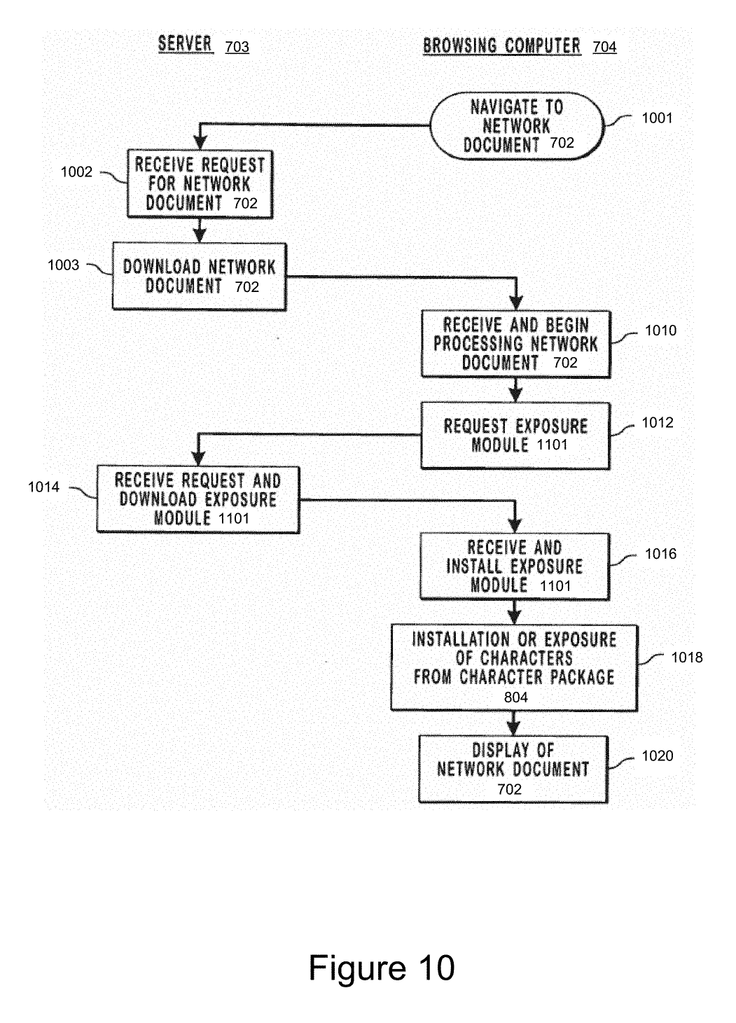

Depicted in FIG. 10 is a flow chart showing the method of operation between browsing computer 704 and server 703. Actions performed primarily by server 703 are listed in the left column while actions performed primarily by browsing computer 704 are listed in the right column. In an act 1001, browsing computer 1001 navigates to network document 702 by generating a request for network document 702 and communicating the request to server 703 in accordance with a transport protocol such as, for example, HyperText Transport Protocol (HTTP). In general, browsing computer 704 navigates to network document 702 by either typing in the URL for network document 702 or activating a link thereto.

In act 1002, server 703 receives the request for network document 702. In response to this request, server 703 downloads network document 702 to browsing computer 704 (act 1003). Network document 702 includes either directly or indirectly, such as through a reference, instruction code 810 and font package 804. As such, instruction code 810 and font package 804 are downloaded with network document 702.

In act 1010, browsing computer 704 receives and begins processing the computer executable instructions within network document 702. In act 1012, browsing computer 704 processes instruction code 810 and requests installation module 1101. The request for installation module 1101 can be automatic which automation can include a prompt. Server 703, in act 1014, receives the request and downloads installation module 1101 to browsing computer 704. In turn, in act 1016, installation module 1101 is installed on browsing computer 704, such as an extension to one or more browsers. Again, the installation of installation module 1101 can be automatic which automation can include a prompt. In tum, installation module 1101 automatically makes font package 804 available to the operating system of browsing computer 704.

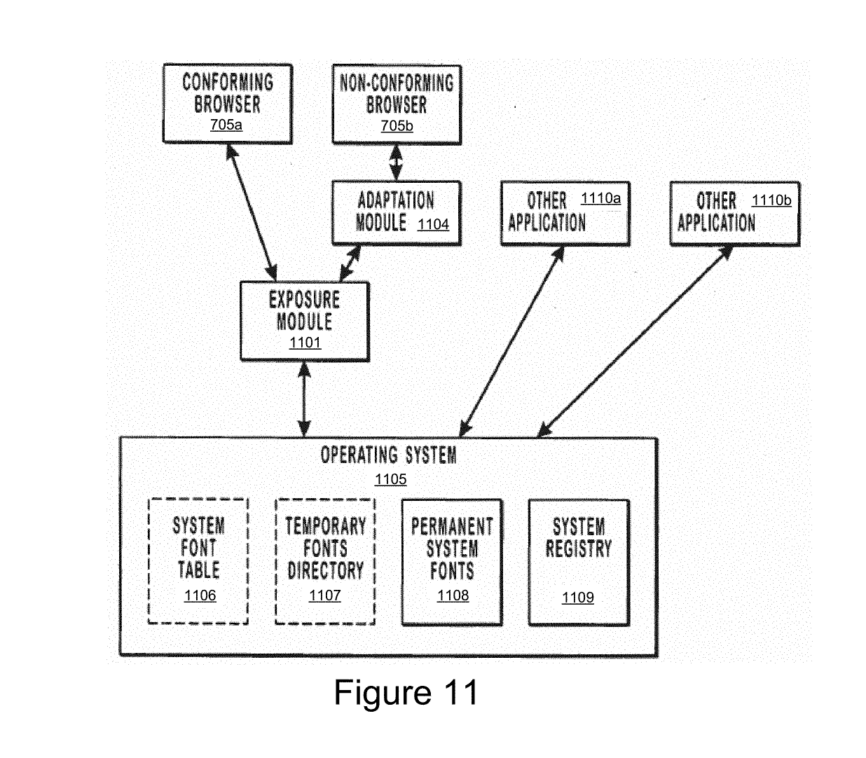

FIG. 11 illustrates installation module 1101 and surrounding elements that are emulated when computer-executable instructions are executed by the processor associated with browsing computer 704. Once downloaded, installation module 1101 communicates with a conforming browser 705A of browsing computer 704 via, for example, function calls and returns. Conforming browser 705A represents browsers that are able to communicate with installation module 1101 without an intermediary module. For example, Microsoft Internet Explorer® may communicate directly with an ActiveX® control without a plug in.

Installation module 1101 also may communicate with non-conforming browser 705B of browsing computer 704. Non-conforming browser 705B represents browsers that are not able to communicate with installation module 1101 without an intermediate module. Accordingly, installation module 1101 communicates with nonconforming browser 705B via an intermediary adaptation module 1104. For example, if installation module 1101 is an ActiveX® control, some browsers such as Netscape® may not communicate directly with installation module 1101. In this case, adaptation module 1104 may be, for example, a plug-in for Netscape® that translates function calls and returns. Thus, the present disclosure may be implemented with a wide variety of browsers.

It is appreciated that adaptation module 1104 can be selectively downloaded from server 703 with installation module 1101 based on the type of browser (conforming or non-con tinning) requesting installation module 1101. Alternatively, adaptation module 1104 can be incorporated into installation module 1101 and thus always downloaded but only accessed when needed.

Browsers 705A and/or 705B can also determine whether installation module 1101 has been previously downloaded to browsing computer 704. If so, redundant downloading of installation module 1101 may be avoided In addition, the MIME type used in requesting installation module 1101 can also identify the desired version for installation module 1101. The browser can thus check the previously installed installation module 1101 and if old, download the new version. With Internet Explorer, the version checking can be done by checking the HTML CODEBASE version specified. In Netscape Navigator® a special JavaScript® code can be used to check the version number.

As depicted in FIG. 11, once installed, installation module 1101 also communicates with operating system 1105 of browser computer 704, thereby accessing all the wealth of resource offered by the operating system 1105.

As depicted in FIG. 10 and FIG. 11, in act 1018, to enable operating system 1105 to access the formatting information within font package 804 the formatting information thereof is either permanently installed on or temporarily exposed to operating system 1105. Initially, as part of the installation process, installation module 1101 first decompresses, if previously compressed, and deciphers, if previously encrypted, character objects 903 and font files 812 along with the header information contained within font package 804. Once decompressed and deciphered, character objects 903 and font files 812 are automatically either permanently installed on or temporarily exposed to operating system 1105 by installation module 1101. Temporary exposure may occur, for example, when it is desired to limit the use or life of the non-standard characters. Permanent installation can be used to allow perpetual unrestricted use of the non-standard characters.

To facilitate permanent installation, character objects 903 and corresponding referenced font files 812 are copied into the same directory as the other standard or permanent system fonts 1108. For example, permanent system fonts are typically stored in a system fonts directory. The system registry 1109 is then updated to reflect the addition of the new permanent character objects 903 and corresponding font files 812.

To facilitate temporary exposure, character objects 903 and font files 812 are copied into a temporary fonts directory 1107. Temporary fonts directory 1107 may be located so as not to be directly accessible by a user. For example, character objects 903 and font files 812 can be copied into hidden temporary files. Virtual memory mapped files are used to enable operating systems 1105 to access the hidden temporary files. Alternatively, character objects 903 and font files 812 can also be copied to virtual memory files. Once temporary fonts directory 1107 is created, system font table 1106 is updated to reflect the new temporary font files 812. In one embodiment, the installed font files 812 are enumerated in a virtual memory array to ensure that any existing fonts with the same name are not replaced.

Once installed or exposed, all of the currently running applications may be notified of new font files 812 via, for example, a standard WM_FONTCHANGE message with HWND_BROADCAST as the target message. Server 703 may be notified of the successful installation of character objects 903 and font files 812 via a callback to a JavaScript® as the target message. Server 203 may Netscape Navigator®, this notification may be accomplished via Live Connect®, this notification may be accomplished via Live Connect®, Component Object Model (COM).

Temporary fonts directory 1107, which contains character objects 903 and font files 812, can be removed or at least become inaccessible through a variety of different mechanisms. For example, installation module 1101 can be programmed to automatically delete character objects 903 and font files 812 via a JavaScript®, can be removed or at least become inaccessible through a variety of different mechanisms. For volatile nature of hidden temporary files and virtual memory mapped files, these files are either erased or become inaccessible to operating system 1105 once browsing computer 704 is shut down or rebooted.

In act 1020 of FIG. 10, once font files 812 are enabled on browsing computer 704, operating system 1105 uses font files 812 to generate the display of network document 702 in the same form that it was originally created. One of the unique benefits of the present disclosure is that once font files 812 are enabled on browsing computer 704, the characters within font files 812 can be used the same as any of the font characters originally loaded on browsing computer 704. For example, the characters of font files 812 can be cut, pasted, printed and otherwise handled or manipulated, i.e., underlined, italicized, bolded, etc., just the same as originally loaded font characters. In tum, this increases efficient inter-application functionality. For example, the characters of font files 812 can also be copied and pasted to any other application being control by operating system 1105, for example, applications 1110a or 1110b as depicted in FIG. 11.

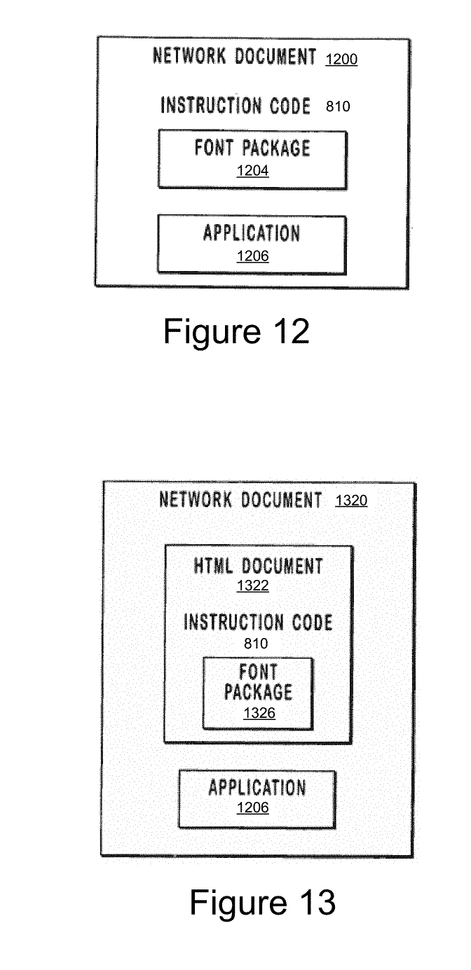

The above described method is only one embodiment of the application of the present disclosure. By way of example and not by limitation, depicted in FIG. 12 is a network document 1200 which is in HTML. Network document 1200 can be posted on a server, attached to an e-mail, recorded on a computer disk or CD, or recorded on any other type of computer readable media which can be requested by or transferred to browsing computer 704 for opening by browser 705.

Embedded within network document 1200 or included by a linked reference is an application 1206. Application 1206 can comprise any type of application program, application file, plugin, or ActiveX® that generates or includes one or more display characters. Also embedded within network document 1200 or included by a linked reference is a font package 1204. Font package 1204 includes one or more font files which contain the formatting information necessary for the creation of the non-standard display characters of application 1206. If desired, character objects containing handling information can also be incorporated into font package 1204. In this embodiment, font package 1204 may be created completely independent of application 1206.

In substantially the same manner as discussed above with regard to FIG. 10, as browser 705 opens and begins processing network document 1200, instruction code 810 embedded therein requests installation module 501 which is downloaded by server 703. In turn, installation module 1101 either permanently installs or temporarily exposes the font files of font package 1204 on browsing computer 704. Accordingly, as application 1206 is opened or run so as to generate the display characters thereof, the non-standard display characters are displayed in their intended configuration.

In yet another embodiment, as depicted in FIG. 13, a network document 1220 comprises an email. Typed directly on the email can be one or more display characters. Alternatively or in combination therewith, an application 1230 can be attached to network document 1220. Application 1230 can comprise any type of application program or file that generates or includes one or more display characters.

Also attached to network document 1220 is an HTML document 1222. Embedded within HTML document 1222 or included by reference is a font package 1226. Font package 1226 includes one or more font files which contain the formatting information necessary for the creation of the non-standard display characters typed on the email and/or which are to be generated or included in application 1230.

During use, network document 1220 is emailed to browsing computer 704 and opened thereon. In turn, HTML document 1222 is selected and then opened by browser 705. As above, as browser 705 processes HTML document 1222, instruction code 810 embedded therein requests installation module 1101 which is downloaded by server 703. In tum, installation module 1101 either permanently installs or temporarily exposes the font files of font package 1226 on browsing computer 704. In turn, the nonstandard characters typed on the email body portion of network document 1220 can be appropriately displayed. Furthermore, as application 1206 is opened or run so as to generate display characters, the non-standard display characters can be displayed in their intended configuration.

The present disclosure also envisions that an HTML document containing a font package and instruction code 810 can also be delivered to browsing computer 704 completely separate from an HTML document, application program, or application file that contains corresponding non-standard display characters. That is, once font files are permanently installed or temporarily exposed on browsing computer 704, an HTML document, application program, or application file that was either previously or subsequently loaded can be run or opened. The non-standard display character generated by the document, program, or file can then be appropriately displayed as a result of the loaded font files.

Thus, the principles of the present disclosure allow the operating system of a browsing computer access to non-standard characters when the browsing computer either retrieves off of the Internet or otherwise opens a network document or application that uses the non-standard characters. This allows the author of the electronic document or application to feel secure that no matter how unique the characters chosen to convey a message, the characters will be rendered on the browsing computer as the author intended. In addition, in one embodiment, the operating system can now use the nonstandard characters for copying and pasting across applications, as well as any other editing or printing that is enabled by the operating system, thus enhancing the functionality to the end user.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A computer-implemented method, at least a portion of the method being performed by a computing device comprising at least one processor, the method comprising:
creating a typelet, the typelet being a visual enhancement of text including: custom non-standard font, text color, stroke color, gradient color, opacity, alignment, pattern, shadow, glow, underline, container graphic, spacing, bold, italics, line spacing, skew, path, rotation, or size;
packaging the typelet into a file that includes information for automatically installing the typelet and rendering the visual enhancement of text using the typelet; and
transmitting the file across a computer network from a first computer to a second computer for automatically installing the typelet and rendering the visual enhancement of text using the typelet on the second computer.

2. The computer-implemented method of claim 1, wherein the file includes a one or more scalable vector graphic images for the visual enhancement of text.

3. The computer-implemented method of claim 2, wherein the file includes one or more non-standard fonts.

4. The computer-implemented method of claim 2, wherein at least one of the scalable vector graphic images is a text bubble with text path.

5. The computer-implemented method of claim 1, wherein the second computer includes a mobile application to receive and process the file.

6. The computer-implemented method of claim 1, wherein transmission of the file across the computer network is in response to a web service call from the second computer to the first computer.

7. A non-transitory computer readable storage medium comprising program instructions executable to:
receiving, at a first computer, a typelet package that includes information for automatically installing a typelet and rendering visual enhancements of text using the typelet, the typelet being a visual enhancement of text including: custom non-standard font, text color, stroke, stroke color, gradient color, opacity, alignment, pattern, shadow, glow, underline, scalable vector graphics, spacing, bold, italics, kerning, leading, blur, line spacing, skew, path, rotation, or size; and
exposing, at the first computer, the typelet to an operating system of the first computer using the typelet package.

8. The non-transitory computer readable storage medium of claim 7, wherein the exposure of the typelet to the operating system is temporary.

9. The non-transitory computer readable storage medium of claim 7, wherein in exposing the typelet to the operating system the operating system is able to copy, paste, print, modify, and edit characters of the typelet.

10. The non-transitory computer readable storage medium of claim 7, wherein the typelet package includes a background image for the visual enhancement of text.

11. The non-transitory computer readable storage medium of claim 10, wherein the background image is a scalable vector graphic.

12. The non-transitory computer readable storage medium of claim 11, wherein the scalable vector graphic is a text bubble.

13. The non-transitory computer readable storage medium of claim 7, wherein the first computer includes a mobile application to receive and process the typelet package.

14. The non-transitory computer readable storage medium of claim 7, wherein receiving the typelet package is in response to a web service call from the first computer.

15. A system comprising:
a means to create a typelet that includes information for automatically installing the typelet and rendering visual enhancements of text using the typelet, the typelet being a visual enhancement of text including: custom non-standard font, text color, stroke, stroke color, gradient color, opacity, scalable vector graphics, alignment, pattern, shadow, glow, underline, container graphic, spacing, bold, italics, kerning, leading, blur, line spacing, skew, path, rotation, or size;
a means to package the typelet into a package; and
a means to distribute the package across a computer network from a first computer to a second computer; and
a means to expose the typelet to an operating system of the second computer using the package.

16. The system of claim 15, wherein the exposure of the typelet to the operating system is temporary.

17. The system of claim 15, wherein in exposing the typelet to the operating system the operating system is able to copy, paste, print, modify, and edit characters of the typelet.

18. The system of claim 15, wherein the package includes a background image for the visual enhancement of text.

19. The system of claim 18, wherein the background image is a scalable vector graphic.

20. The system of claim 19, wherein the scalable vector graphic is a text bubble.

21. The system of claim 17, wherein the package includes file includes a one or more scalable vector graphic images for the visual enhancement of text.

22. The system of claim 17, wherein the package includes one or more non-standard fonts.
